(19) United States
(12) Patent Application Publication
(10) Pub. No.: US 2024/0244329 A1
(43) Pub. Date: Jul. 18, 2024

(54) AUTOMATIC REFRAMING

(71) Applicant: Apple Inc., Cupertino, CA (US)

(72) Inventors: Onur E. TACKIN, Saratoga, CA (US); Dhruv SAMANT, Mountain View, CA (US); Samuel D. POST, Great Falls, MT (US); Mahmut DEMIR, Pleasanton, CA (US)

(21) Appl. No.: 18/407,221

(22) Filed: Jan. 8, 2024

Related U.S. Application Data
(60) Provisional application No. 63/439,535, filed on Jan. 17, 2023.

(51) Int. Cl. H04N 23/695; H04L 12/18; H04N 23/611

(52) U.S. Cl. CPC H04N 23/695; H04L 12/1831; H04N 23/611

(57) ABSTRACT

This disclosure provides more effective and/or efficient techniques for image and/or video capture. For example, some techniques include identifying a subject in a view of a camera and, based on the subject, shifting the view of the camera. Shifting the view of the camera based on the subject can allow the computer system to automatically adjust the view of the camera without explicit user input and/or allow the subject to guide the view of the camera without the subject needing to physically move the camera and/or navigate through cumbersome user interfaces. Such techniques optionally complement or replace other techniques for image and/or video capture.

### CROSS-REFERENCE TO RELATED APPLICATIONS

The present application claims priority to U.S. Provisional Patent Application Ser. No. 63/439,535, entitled “AUTOMATIC REFRAMING” filed Jan. 17, 2023, which is hereby incorporated by reference in its entirety for all purposes.

### BACKGROUND

Image and video capture is becoming increasingly popular. For example, people often connect with others through video calls. In such video calls, cameras are typically manually moved by a person to capture different views, perspectives, and/or frames of a physical environment. Accordingly, there is a need to improve techniques for image and video capture of a subject.

### SUMMARY

Current techniques for image and/or video capture are generally ineffective and/or inefficient. For example, some techniques require users to manually move a camera to capture different portions and/or areas of a physical environment. This disclosure provides more effective and/or efficient techniques for image and/or video capture. For example, some techniques include identifying a subject (e.g., a primary subject and/or any subject) in a view of a camera and, based on the subject (e.g., in response to detecting a focus direction of the subject), shifting the view of the camera. Shifting the view of the camera based on the subject can allow the computer system to automatically adjust the view of the camera without explicit user input and/or allow the subject to guide the view of the camera without the subject needing to physically move the camera and/or navigate through cumbersome user interfaces. Such techniques optionally complement or replace other techniques for image and/or video capture.

In some examples, a method is described that is performed by an electronic device. In some examples, the method comprises: receiving, via a camera that is in communication with a computer system, data representing a view of the camera; identifying, based on the data, a first subject as a primary subject in the view of the camera; after identifying the first subject as the primary subject in the view of the camera, detecting that a focus direction of the first subject is in a second direction; and in response to detecting that the focus direction of the first subject is in the second direction, shifting the view of the camera.

In some examples, a non-transitory computer-readable storage medium storing one or more programs configured to be executed by one or more processors is described. In some examples, the one or more programs includes instructions for: receiving, via a camera that is in communication with a computer system, data representing a view of the camera; identifying, based on the data, a first subject as a primary subject in the view of the camera; after identifying the first subject as the primary subject in the view of the camera, detecting that a focus direction of the first subject is in a second direction; and in response to detecting that the focus direction of the first subject is in the second direction, shifting the view of the camera.

In some examples, a transitory computer-readable storage medium storing one or more programs configured to be executed by one or more processors is described. In some examples, the one or more programs includes instructions for: receiving, via a camera that is in communication with a computer system, data representing a view of the camera; identifying, based on the data, a first subject as a primary subject in the view of the camera; after identifying the first subject as the primary subject in the view of the camera, detecting that a focus direction of the first subject is in a second direction; and in response to detecting that the focus direction of the first subject is in the second direction, shifting the view of the camera.

In some examples, an electronic device comprising one or more processors and memory storing one or more program configured to be executed by the one or more processors is described. In some examples, the one or more programs includes instructions for: receiving, via a camera that is in communication with a computer system, data representing a view of the camera; identifying, based on the data, a first subject as a primary subject in the view of the camera; after identifying the first subject as the primary subject in the view of the camera, detecting that a focus direction of the first subject is in a second direction; and in response to detecting that the focus direction of the first subject is in the second direction, shifting the view of the camera.

In some examples, an electronic device comprising means for performing each of the following steps: receiving, via a camera that is in communication with a computer system, data representing a view of the camera; identifying, based on the data, a first subject as a primary subject in the view of the camera; after identifying the first subject as the primary subject in the view of the camera, detecting that a focus direction of the first subject is in a second direction; and in response to detecting that the focus direction of the first subject is in the second direction, shifting the view of the camera.

In some examples, a computer program product is described. In some examples, the computer program product comprises one or more programs configured to be executed by one or more processors. In some examples, the one or more programs include instructions for: receiving, via a camera that is in communication with a computer system, data representing a view of the camera; identifying, based on the data, a first subject as a primary subject in the view of the camera; after identifying the first subject as the primary subject in the view of the camera, detecting that a focus direction of the first subject is in a second direction; and in response to detecting that the focus direction of the first subject is in the second direction, shifting the view of the camera.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described examples, reference should be made to the Detailed Description below, in conjunction with the following drawings in which like reference numerals refer to corresponding parts throughout the figures.

FIG. 1 is a block diagram illustrating a compute system in accordance with some examples.

FIG. 2 is a block diagram illustrating a device with interconnected subsystems in accordance with some examples.

FIGS. 3A-3J are block diagrams illustrating techniques for video capture in accordance with some examples.

FIG. 4 is a flow diagram illustrating a method for shifting a view of a camera in accordance with some examples.

### DETAILED DESCRIPTION

The following description sets forth exemplary techniques, methods, parameters, systems, computer-readable storage mediums, and the like. It should be recognized, however, that such description is not intended as a limitation on the scope of the present disclosure. Instead, such description is provided as a description of the examples provided herein.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described examples. In some examples, the first subsystem and the second subsystem are two separate references to the same subsystem. In some examples, the first subsystem and the second subsystem are both subsystems, but they are not the same subsystem or the same type of subsystem.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

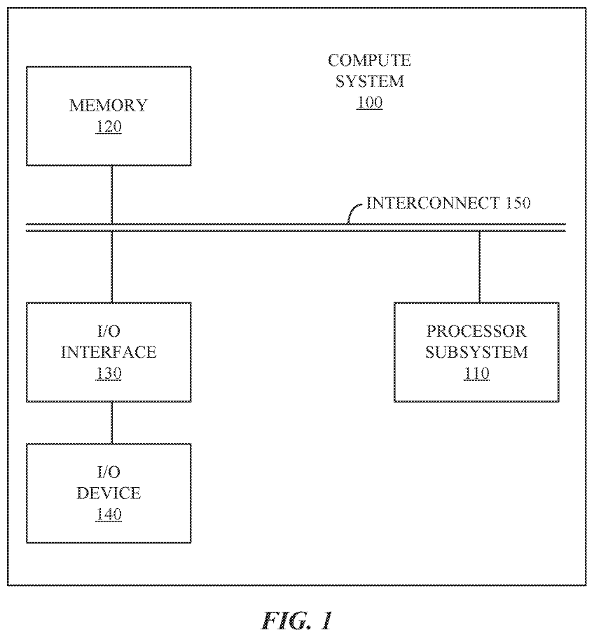

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more I/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included or communicating with a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gearbox, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 800, 900, 1000, 11000, 12000, 1300, 1400, and 1500 described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

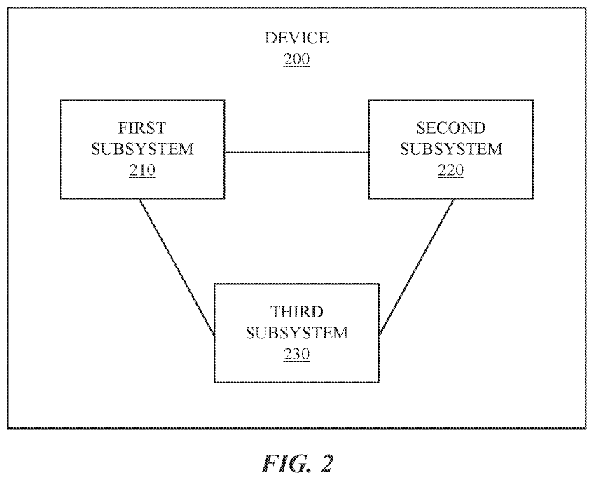

FIG. 2 illustrates a block diagram of device 200 with interconnected subsystems in accordance with some examples. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

Attention is now directed towards techniques for image and/or video capture. For example, some techniques include identifying a subject in a view (e.g., sometimes referred to as a perspective and/or a frame) of a camera and, in response to detecting a focus direction of the subject, shifting the view of the camera. Shifting the view of the camera based on the focus direction of the subject can allow the subject to guide the view of the camera without the subject needing to physically move the camera and/or navigate through cumbersome user interfaces. Such techniques are described in the context of an on-going video call using previous frames of the video call to determine whether to automatically shift a view of a camera. In this context, the video call is between two computer systems (e.g., a smartphone, a smart watch, a fitness tracking device, a laptop, a tablet, and/or other type of computer system), with at least one of the computer systems in communication with and/or including a camera recording video to be sent to the other computer system. It should be recognized that other contexts can be used with techniques described herein. For example, techniques described herein can be used to automatically shift a view of a camera before receiving input (e.g., user input corresponding to an instruction) to initiate capture of an image and/or video. In addition, techniques optionally complement or replace other techniques for image and/or video capture.

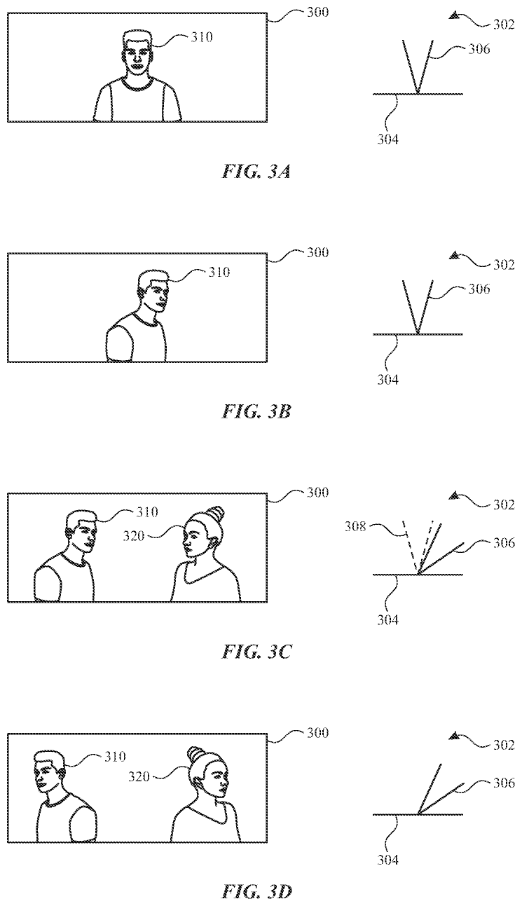

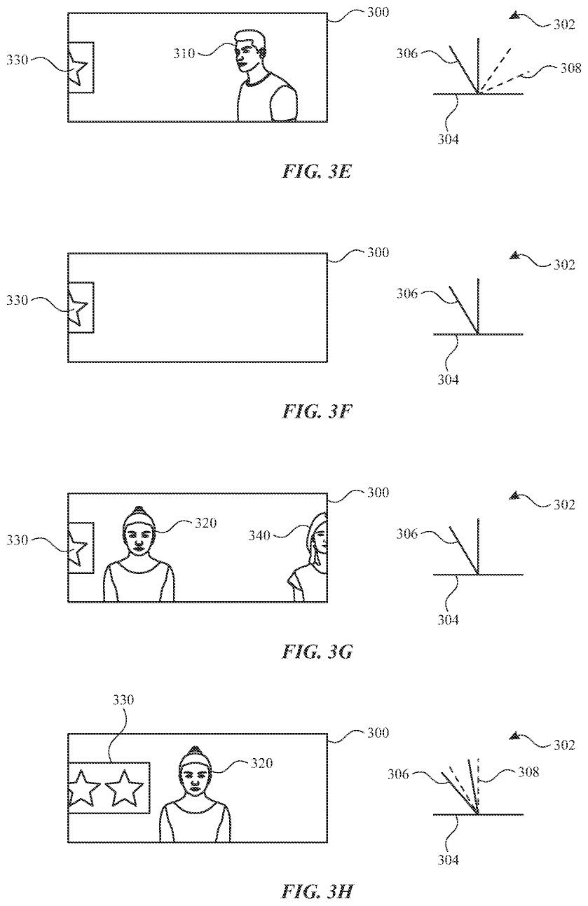

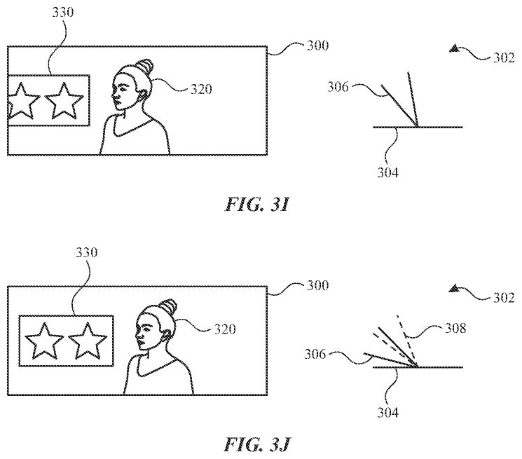

FIGS. 3A-3J are block diagrams illustrating techniques for video capture in accordance with some examples. The block diagrams include camera frame 300 on the left and schematic 302 on the right. Schematic 302 includes plane 304 with view 306. View 306 represents a view of a camera that captured camera frame 300. For example, view 306 in FIG. 3A represents that the view of the camera is straight ahead to capture camera frame 300 in FIG. 3A. In some examples, a representation of camera frame 300 is displayed by a computer system that has one or more components of compute system 100 and/or device 200 described above. In some examples, the computer system includes one or more cameras that includes the camera described herein.

In FIG. 3A, camera frame 300 includes person 310 looking towards the camera. In some examples, camera frame 300 is a first image captured by the camera as part of a capture session (e.g., a video call and/or a video communication session). In some examples, the computer system identifies person 310 and determines that there is not another person in the view of the camera. Based on the determination, the computer system can identify person 310 as the primary subject in the view of the camera (e.g., because person 310 is the only person in the view) and determine to modify the view of the camera based on where person 310 is looking (e.g., a focus direction of person 310). In other examples, the computer system can identify person 310 as the primary subject in the view of the camera and determine to modify the view of the camera based on person 310 being identified as the primary subject in the view of the camera. For example, the computer system can modify the view of the camera to frame person 310 in a different manner (e.g., before modifying the view, person 310 can only be partly within the view of the camera). For another example, the computer system can identify an area within the environment that is likely and/or determined to be of interest of the primary subject and, in response, modify the view of the camera in a direction of the area (e.g., make the view of the camera include the area and/or move in the direction of the area without moving such that the view of the camera includes the area).

It should be recognized that person 310 can be identified as the primary subject in the view of the camera based on one or more determinations described herein. For example, in addition to and/or instead of person 310 being the only person in the view of the camera, person 310 can be an owner of the computer system and/or the camera. In such an example, the computer system can either only identify the owner as the primary subject or identify the owner as the primary subject when the owner is one of multiple people in the view of the camera. Such identification can be via a comparison of one or more features of the owner (e.g., stored and/or received by the computer system) with one or more features of person 310 using camera frame 300. For another example, person 310 can be identified as the primary subject in the view of the camera when person 310 has recently been identified as the primary subject, even if there has not been an identified primary subject for a predefined amount of time (e.g., 1-10 minutes). In such an example, return of person 310 with other possible subjects in the view of the camera can result in person 310 being identified as the primary subject. For another example, person 310 is identified as the primary subject because a determination is made that person 310 is closer in proximity to a center of the view of the camera and/or to the camera (and/or the computer system) than other subjects. For another examples, primary person 310 is identified as the primary subject based on an analysis of a photo gallery associated with the computer system. In such an example, the photo gallery can store one or more photos and/or videos and the primary subject can be identified based on a number of times that a subject is identified in the one or more photos and/or videos (e.g., when the subject is identified more than a threshold number of times, the subject is identified as the primary subject). In some examples, the photo gallery is stored on the computer system. In other examples, the photo gallery is stored on a computer system separate from the computer system, such as a remote server. In some examples, instead of the subject being identified as the primary subject because of the number of times that the subject is identified in the one or more photos and/or videos, the photo gallery can have a subject designated as an owner of the photo gallery (e.g., manually by a user and/or automatically by comparing different photos and/or videos of the photo gallery) and that subject would then be identified as the primary subject. In some examples, a subject can be identified as the primary subject based on a current and/or recent activity level of the subject relative to other subjects in the view of the camera, such as the subject more recently speaking, gazing (and/or looking) for longer at the camera and/or the computer system, gazing and/or looking at the camera and/or the computer system more recently, talking more, moving more, blinking more, and/or performing one or more particular types of gestures more than other subjects in the view of the camera. In some examples, a subject can be identified as the primary subject based on a current and/or recent activity level of the subject being above a certain threshold. In some examples, multiple subjects can be identified as primary subjects.

It should also be recognized that other types of subjects besides a person can be identified as the primary subject. For example, animals, objects, and/or other types of subjects known by a person of ordinary skill in the art can be identified as the primary subject using one or more determinations, such as those described herein.

In some examples, the focus direction of a primary subject is determined by identifying where the primary subject is looking by, for example, identifying a direction of the primary subject's gaze via the orientation of the subject's face and/or one or more portions of the subject's face, such as the subject's eyes, nose, and/or ears. In other examples, the focus direction of the primary subject is determined by identifying a gesture made by the primary subject (e.g., pointing in a direction, leaning in a direction, nodding toward a direction, etc.). It should be recognized that the focus direction can be determined in other ways known by a person of ordinary skill in the art.

In some examples, the focus direction of person 310 in FIG. 3A is determined to be toward the camera and, as a result, a determination is made that the view of the camera does not need to be changed. In other examples, the focus direction of person 310 being toward the camera can cause the computer system to either zoom-in or zoom-out to expand or shrink the view of the camera (and/or, in some examples, switch to a different type of camera (e.g., a telephoto camera to a wide-angle camera, or vice-versa)).

FIG. 3B illustrates person 310 looking to the right in camera frame 300. At FIG. 3B, a determination is made that person 310 wishes to change (e.g., shift, move, translate, and/or, in some examples, select another camera to change) the view of the camera to the right. In some examples, a determination is made that person 310 wishes to change the view of the camera after determining that person 310 has been looking in a particular direction (e.g., to the right) for at least a predefined amount of time (e.g., 2 seconds, 3 seconds, etc.). In such examples, the computer system can cause the view of the camera to change (e.g., changing and/or shifting the x, y, z, pitch, yaw, or roll of the camera) in the particular direction and/or in a direction corresponding to the particular direction (e.g., looking up and to the right causes the view to be changed to the right but not up), as illustrated in FIG. 3C.

FIG. 3C illustrates camera frame 300 including person 310 and person 320. In some examples, camera frame 300 includes both person 310 and person 320 because the computer system has caused the view of the camera to be moved relative to FIG. 3B. For example, in FIG. 3C, schematic 302 illustrates that view 306 has moved to the right, with previous view 308 (e.g., view 306 in FIG. 3B) illustrated as a dotted line. As described above, view 306 moved to the right based on determining that the focus direction of person 310 was to the right.

In some examples, the movement of view 306 is gradual and continues until a determination is made that the movement should be stopped. For example, in FIG. 3C, the movement stopped once person 320 is at a predefined location in camera frame 300, such as all of person 320 is in camera frame 300 and/or a particular amount of additional area after person 320 is in camera frame 300. In some examples, the movement continues until either (1) more movement would cause the primary subject to not be in camera frame 300 anymore and/or (2) another object (and/or subject), determined to be the focus of the primary subject, is at least partially within (and/or entirely within) camera frame 300.

In some examples, the movement of view 306 is in the same direction as the focus direction of person 310. For example, if the focus direction of person 310 is to the right, the movement is to the right. For another example, if the focus direction of person 310 is up and to the right, the movement is up and to the right. In other examples, the computer system selects a primary direction (e.g., up, down, left, or right) based on a direction that person 310 is primarily looking (e.g., if looking more up than right, the primary direction would be right) and the movement is in the primary direction. In other examples, the computer system identifies an object (and/or subject) that the computer system determines is a focus of the primary subject and moves in the direction of the object.

In some examples, the computer system causes the view of the camera to be moved by activating a component of the camera, such as an actuator that is part of the camera, where movement of the actuator causes the view to be changed and/or shifted. For example, the actuator can move the lens of the camera to a different direction and/or to be oriented differently so that the view of the camera is changed. It should be recognized that other components known by a person of ordinary skill in the art can be moved in addition to or instead of the lens to result in moving the view of the camera.

In other examples, the computer system causes the view of the camera to be moved by activating a component of the computer system, such as an actuator that is part of the computer system but separate from the camera. In such examples, the computer system can include and/or be in communication with the camera. For example, the computer system can be a smartphone with a camera inside of a housing of the smartphone. In such an example, the actuator can be part of the smartphone and cause the smartphone to be moved so that the camera is moved. For another example, the computer system can be a mount that is physically or magnetically coupled to (1) a smartphone including the camera and/or (2) the camera. In such an example, the mount includes the actuator and causes the camera (and/or the smartphone) to be moved by moving the mount with the actuator.

In other examples, the computer system causes the view of the camera to be moved by performing a software-based operation that changes the view without physically moving the camera. For example, the camera can capture a view bigger than illustrated in camera frame 300. In such an example, camera frame 300 in FIG. 3B and camera frame 300 in FIG. 3C can each be the result of cropping the view captured by the camera. It should be recognized that other software-based operations known by a person of ordinary skill in the art can be performed to change the view of the camera.

FIG. 3D illustrates person 310 and person 320 are no longer looking at each other in camera frame 300. In particular, person 310 has changed from looking at person 320 to looking to the left, and person 320 has changed from looking at person 310 to looking to the right. The computer system can identify the change in focus direction of one or more of the people and determine whether to move the view of the camera. In some examples, the computer system identifies the primary subject in camera frame 300 and determines the focus direction of the primary subject to determine whether to move the view of the camera. In such examples, person 310 can be identified as the primary subject because person 310 has been most recently identified as the primary subject (e.g., in FIG. 3C) and the computer system has not determined to change the primary subject.

FIG. 3E illustrates the view of the camera has moved to the left relative to FIG. 3D. As illustrated by schematic 302 of FIG. 3C, view 306 has moved to the left of where it previously was (e.g., previous view 308, corresponding to view 306 in FIG. 3D, and view 306 in FIGS. 3A-3B). In some examples, the view of the camera is moved left based on a determination that the primary subject (e.g., person 310, the person identified as the primary subject in FIGS. 3D-3E) is looking to the left. In such examples, the determination can be that the primary subject is looking at picture 330, causing the view of the camera to move to make picture 330 visible in camera frame 300.

In some examples, camera frame 300 is not big enough to include both person 310 and all of picture 330. In such examples, because camera frame 300 is not big enough to include both person 310 and all of picture 330, the computer system determines how much to shift the view of the camera based on which detects objects should be included in camera frame 300. As illustrated in FIG. 3E, camera frame 300 includes all of person 310 in camera frame 300 because a determination is made that all of person 310 should be included in camera frame 300. In some examples, the computer system can determine to include less of person 310 and/or more of picture 330 in camera frame 300, resulting in at least a portion of person 310 not being included in camera frame 300.

FIG. 3F illustrates person 310 no longer in camera frame 300. In some examples, based on person 310 no longer being in camera frame 300 (e.g., for at least a predefined period of time (0-10 minutes)), the computer system determines that person 310 is no longer the primary subject. In such examples, the computer system can search for a different primary subject. In some examples, the computer system determines that painting 330 is the primary subject and changes the view of the camera to include painting 330. In other examples, the computer system continues to search for a new primary subject, such as another person, with or without moving the view of the camera.

FIG. 3G illustrates person 320 and person 340 are captured in camera frame 300. In some examples, person 320 and person 340 entered camera frame 300 at the same time and so neither of them were in camera frame 300 by themselves. In other examples, one of the people entered camera frame 300 first but their presence in camera frame 300 did not raise to the level of the person being identified as the primary subject (e.g., the person stayed on an edge of camera feed 300 and/or was not present in camera frame 300 for long enough to be identified as the primary subject). In some examples, the computer system uses one or more of the determinations described above to identify a person as the primary subject. In some examples, the computer system identifies person 320 as the primary subject based on person 320 being identified in camera frame 300 more recently than person 340 and/or person 320 being closer to a center of camera frame 300.

FIG. 3H illustrates the view of the camera moved to the left relative to FIG. 3G. As illustrated by schematic 302 of FIG. 3H, view 306 has moved to the left of where it previously was (e.g., previous view 308, corresponding to view 306 in FIG. 3G). In some examples, the view of the camera is moved left based on identifying person 320 as the primary subject.

In some examples, camera frame 300 is not big enough to include both person 320 in the center of camera frame 300 and all of picture 330. In such examples, because camera frame 300 is not big enough to include both person 320 in the center of camera frame 300 and all of picture 330, the computer system determines how much to shift the view of the camera based on which detected objects should be included in camera frame 300. As illustrated in FIG. 3H, camera frame 300 include person 320 in the center of camera frame 300, because a determination is made that person 320 is the primary subject (e.g., and is not focusing attention on picture 330) and that person 320 should be placed in the center of camera frame 300, and only a portion of picture 330 in camera frame 300. In some examples, the computer system determines to include as much of both person 310 and picture 330 in camera frame 300 as possible, resulting in person 320 not being in the center of camera frame 300.

FIG. 3I illustrates person 320 looking to the left. At FIG. 3I, a determination is made that the focus direction of person 320 is to the left and that the view of the camera should be moved to the left. In some examples, the computer system determines that the focus direction of person 320 is to the left after determining that person 320 has been looking in a particular direction (e.g., to the left) for at least a predefined amount of time (e.g., 2 seconds, 3 seconds, etc.). In such examples, the computer system can cause the view of the camera to change (e.g., changing and/or shifting the x, y, z, pitch, yaw, or roll of the camera) in the particular direction and/or in a direction corresponding to the particular direction (e.g., as described above).

FIG. 3J illustrates camera frame 300 includes person 320 and picture 330. In some examples, camera frame 300 includes both person 320 and picture 330 because the computer system has caused the view of the camera to be moved relative to FIG. 3I. For example, in FIG. 3J, schematic 302 illustrates that view 306 has moved to the left, with previous view 308 (e.g., view 306 in FIG. 3I) illustrated as a dotted line. In some examples, view 306 moved to the left as based on determining that the focus direction of person 320 was to the left. Such movement of the camera can be the same or similar to as described above with respect to FIG. 3C.

As mentioned above, in some examples, operations described above are performed while the computer system including the camera is on a video call with the other computer system. In such examples, the computer system can be sending one or more images and/or video to the other computer system as part of the video call. For example, camera frame 300, as illustrated in any one of FIGS. 3A-3J, can be sent to the other computer system by the computer system. While discussed above as changing the view of the camera based on a focus direction of a person, it should be recognized that the computer system can (1) change the view of the camera based on other determinations and/or (2) operate in different modes at different times that cause the computer system to change the view of the camera based on different determinations. For example, the computer system can receive a pose from the other computer system and change the view of the camera based on the pose. In such an example, the other computer system can be a HMD device that sends a pose of the HMD device as a person wearing the HMD device moves their head. When their head moves, the other computer system can send an updated pose of the HMD device to the computer system so that the computer system can change the view of the camera to match and/or correspond to the pose of the HMD device. Changing the view of the camera to match and/or correspond to the pose of the HMD device can allow the person wearing the HMD device to control the view of the camera without requiring a person near the camera to move the camera. In some examples, a user of the computer system and/or the other computer system can switch a mode of the computer system between a mode in which the computer system operates based on a person within a view of the camera and/or a pose received from the other computer system. For example, the computer system can detect the user of the computer system to select a user interface element and/or verbally request that the computer system change to the mode in which the computer system operates based on a pose received from the other computer system. For another example, the computer system can receive a request from the other computer system to operate based on a pose received from the other computer system and, as a result (e.g., in response to receiving the request and/or in response to detecting a user of the computer system approve the request), change the computer system to the mode in which the computer system operates based on a pose received from the other computer system.

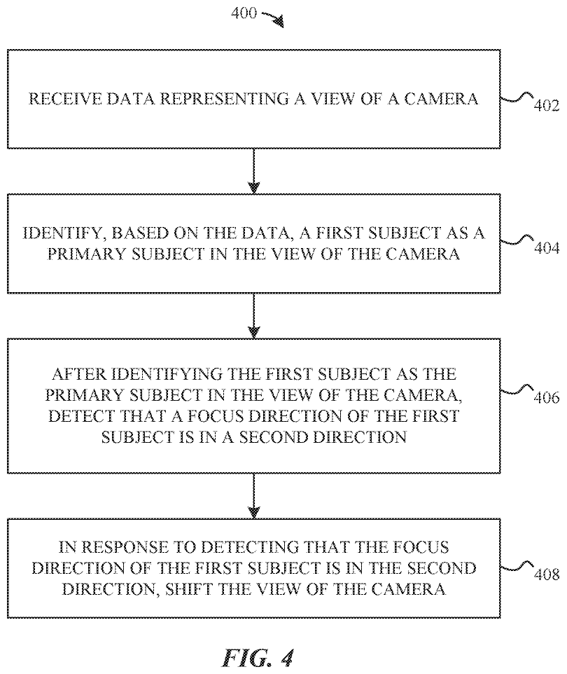

FIG. 4 is a flow diagram illustrating a method (e.g., method 400) for shifting a view of a camera in accordance with some examples. Some operations in method 400 are, optionally, combined, the orders of some operations are, optionally, changed, and some operations are, optionally, omitted.

As described below, method 400 provides an intuitive way for shifting the view of the camera. Method 400 reduces the cognitive burden on a user for shifting the view of the camera, thereby creating a more efficient human-machine interface. For battery-operated computing devices, enabling a user to shift the view of the camera faster and more efficiently conserves power and increases the time between battery charges.

In some examples, method 400 is performed by an electronic device. The electronic device can be, include, and/or be in communication with a camera. For example, the electronic device can be a user device (such as a smartphone and/or a smart watch) that includes the camera. For another example, the electronic device can be a mount (e.g., a mounting device) that couples (e.g., wired, wirelessly, and/or magnetically) to another electronic device that is the camera or includes the camera.

At 402, the electronic device receives, via the camera that is in communication with a computer system, data (e.g., one or more images and/or one or more signals) (e.g., 300) representing a view of the camera (e.g., the camera captured the image and sends the image to the computer system). In some examples, the data is an image of a first portion of a physical environment. In some examples, the data is a description, identification, and/or an indication of one or more objects in a physical environment. In some examples, the data is received while the computer system is in communication (e.g., via a call (e.g., a video call)) with another computer system. In some examples, the data is sent to the other computer system via the communication (e.g., as part of the call). In some examples, the electronic device is the computer system. In some examples, the electronic device is in communication with the computer system.

At 404, the electronic device identifies, based on the data, a first subject (e.g., a person, animal, or an object) (e.g., 310) as a primary subject in the view of the camera. In some examples, the first subject was previously identified as the primary subject in different data (e.g., a previously captured image) and the first subject is re-identified based on the data.

At 406, after identifying the first subject as the primary subject in the view of the camera, the electronic device detects that a focus direction (e.g., an area of attention, a direction of attention, and/or a direction that the first subject is looking, pointing, and/or gesturing) of the first subject is in a second direction. In some examples, the electronic device detects that the focus direction of the first subject has changed from a first direction to the second direction (e.g., the second direction is different from the first direction). In some examples, the electronic device detects that the focus direction of the first subject is in the second direction and not that the first subject has changed from being in the first direction to being in the second direction.

At 408, in response to detecting that the focus direction of the first subject is in the second direction, the electronic device shifts (e.g., changes) the view of the camera (e.g., from a first view (e.g., camera frame 300 in FIG. 3B) to a second view (e.g., camera frame 300 in FIG. 3C) different from the first view). In some examples, the shifting occurs in response to detecting that the focus direction of the first subject has changed from being in the first direction to being in the second direction. In some examples, the view of the camera is not shifted when the focus direction of the first subject has not changed. In some examples, the view of the camera is not shifted based on a focus direction of a subject different from the first subject (e.g., a third subject). In some examples, shifting the view of the camera includes causing an image and/or a video captured by the camera to be of a second portion of the physical environment different from the first portion of the physical environment.

In some examples, shifting the view of the camera includes moving (e.g., causing to move) a direction that the camera is facing (e.g., changing a pitch, yaw, or roll of the camera).

In some examples, moving the direction that the camera is facing includes sending, to a second computer system that is different from the computer system (and/or different from the electronic device), a request to move a physical component of the second computer system. In some examples, the second computer system does not include the camera.

In some examples, the first subject is identified as the primary subject based on a proximity of the first subject to a center of the view of the camera. In some examples, the first subject is identified as the primary subject when the first subject is identified as closer to the center of the view of the camera than another subject identified in the data. In some examples, the first subject is not identified (e.g., another subject is identified) as the primary subject when the first subject is identified as farther away from the center of the view of the camera than another subject identified in the data.

In some examples, the first subject is identified as the primary subject based on a proximity of the first subject to the camera. In some examples, the first subject is identified as the primary subject when the first subject is identified as closer to the camera than another subject identified in the data. In some examples, the first subject is not identified (e.g., another subject is identified) as the primary subject when the first subject is identified as farther away from the camera than another subject identified in the data.

In some examples, the first subject is identified as the primary subject based on an analysis of one or more previously captured images (e.g., the one or more previously captured images are not included in the data). In some examples, the one or more images are included in a photo gallery of a photo application, such as a photo application installed on a user device (e.g., the electronic device, the computer system, or a user device coupled (e.g., wired or wirelessly) to the computer system). In some examples, the first subject is identified as the primary subject when the first subject is identified in a threshold number of previously captured images. In some examples, the first subject is identified as the primary subject when the first subject is identified in more previously captured images than another subject identified in the data. In some examples, the first subject is not identified (e.g., another subject is identified) as the primary subject when the first subject is not identified in the threshold number of previously captured image. In some examples, the first subject is not identified (e.g., another subject is identified) as the primary subject when the first subject is identified in less previously captured images than another subject identified in the data.

In some examples, the first subject is identified as the primary subject based on a length of time that the first subject has been identified in the view of the camera (and/or, in some examples, that the first subject has been communicating more than another subject for a predetermined period of time). In some examples, the first subject is identified as the primary subject when the first subject is an initial subject identified in the view of the camera (e.g., before another subject is identified in the view of the camera). In some examples, the first subject is not identified (e.g., another subject is identified) as the primary subject when another subject is identified in the view of the camera before the first subject. In some examples, the first subject is identified as the primary subject when the first subject is identified in the view of the camera for the longest amount of time (e.g., longer than another subject is identified in the view of the camera). In some examples, the first subject is not identified (e.g., another subject is identified) as the primary subject when the first subject is identified in the view of the camera for a shorter amount of time than another subject.

In some examples, while the first subject is identified as the primary subject, the electronic device identifies that the first subject has not been in the view of the camera for a threshold amount of time (e.g., 1-2 seconds, 1-2 minutes, or a percentage of the length of time that the first person has been identified in the view of the camera). In some examples, in response to identifying that the first subject has not been in the view of the camera for the threshold amount of time, the electronic device identifies a second subject as the primary subject, wherein the second subject is different from the first subject. In some examples, the electronic device detects, based on second data (e.g., a second set of one or more images or one or more signals that is different from the data) received via the camera, a focus direction of the second subject. In some examples, in response to detecting that the focus direction of the second subject has changed from being in a third direction (e.g., the first direction or some other direction) to being in a fourth direction (e.g., the second direction or some other direction), the electronic device shifts the view of the camera. In some examples, the view of the camera is not changed based on a focus direction of a subject different from the second subject (e.g., the first subject or a third subject) when the primary subject is the second subject.

In some examples, shifting the view of the camera, in response to detecting that the focus direction of the first subject is in the second direction, includes moving the view of the camera in the second direction. In some examples, shifting the view of the camera, in response to detecting that the focus direction of the first subject is in the second direction, includes moving the view of the camera in a direction opposite of the second direction.

In some examples, shifting the view of the camera includes moving the view of the camera until the first subject is located at a predefined location within the view (e.g., less than a predefined amount of distance from an edge of the view).

In some examples, shifting the view of the camera includes moving the view of the camera until a subject in the second direction is in the view of the camera.

In some examples, shifting the view of the camera includes moving the view of the camera a predetermined amount that is in a direction of a subject identified to be where the first subject is looking (e.g., irrespective of whether the subject is in the view of the camera after shifting the view of the camera).

In some examples, the computer system includes the camera. In some examples, a third electronic device (e.g., a user device coupled (e.g., wired or wirelessly) to the electronic device), different from the computer system, includes the camera. In some examples, the third electronic device is different from the second computer system.

In some examples, the computer system receives, from another computer system (e.g., a watch, a phone, a tablet, a fitness tracking device, a processor, a head-mounted display (HMD) device, a communal device, a media device, a speaker, a television, and/or a personal computing device) different from the computer system, a respective pose (e.g., a position, a location, and/or an orientation) corresponding to (and/or of) the other computer system. In some examples, the respective pose is included in a request to move the camera and/or the computer system to a pose that matches the respective pose corresponding to the other computer system. In some examples, in response to receiving the respective pose corresponding to the other computer system (and, in some embodiments, after shifting the field of view of the camera in response to detecting that the focus direction of the first subject is in the second direction) and in accordance with a determination that the respective pose is a first pose (and/or that the camera (and/or the computer system) is configured to be controlled by the other computer system (e.g., the computer system and/or the other computer system detected a request for the other computer system to control the camera and/or the computer system)), the computer system shifts (e.g., changes and/or moves) the field of view of the camera to a first field of view. In some examples, shifting the field of view of the camera to the first field of view is not based on (and/or is irrespective of) the focus direction and/or a position (e.g., location and/or orientation) of the first subject. In some examples, in response to receiving the respective pose corresponding to the other computer system (and, in some embodiments, after shifting the field of view of the camera in response to detecting that the focus direction of the first subject is in the second direction) and in accordance with a determination that the respective pose is a second pose different from the first pose (and/or that the camera (and/or the computer system) is configured to be controlled by the other computer system (e.g., the computer system and/or the other computer system detected a request for the other computer system to control the camera and/or the computer system)), the computer system shifts the field of view of the camera to a second field of view different from the first field of view. In some examples, shifting the field of view of the camera to the second field of view is not based on (and/or is irrespective of) the focus direction and/or a position (e.g., location and/or orientation) of the first subject. In some examples, in response to receiving the respective pose corresponding to the other computer system and in accordance with a determination that the respective pose is a third pose different from the first pose and the second pose, the computer system forgoes shifting (and/or maintains) the field of view of the camera. In some examples, in response to and/or after receiving the respective pose corresponding to the other computer system and in accordance with a determination that the camera (and/or the computer system) is configured to be controlled by the other computer system (e.g., the computer system and/or the other computer system detected a request for the other computer system to control the camera and/or the computer system), the computer system forgoes shifting the field of view of the camera based on the respective pose (and, in some embodiments, instead shifts the field of view of the camera based on the focus direction of the first subject). In some examples, when the computer system has not received a pose from the other computer system (e.g., while in a telecommunications call with the other computer system, the computer system shifts the field of view of the camera based on a focus direction and/or a position (e.g., location and/or orientation) of the first subject.

In some examples, the respective pose of the other computer system is received as part of a telecommunication call (e.g., a video, audio, telephone, and/or internet call) between the computer system and the other computer system. In some examples, the telecommunication call is initiated by the computer system or the computer system.

In some examples, after shifting the field of view to the first field of view (e.g., and while still participating in the telecommunication call), the computer system detects, via the camera, movement of the first subject (e.g., while the first subject is identified as the primary subject in the field of view of the camera). In some examples, after (and/or in response to) detecting the movement of the first subject and in accordance with a determination that the computer system is in a first mode (e.g., a mode in which the computer system causes the camera to follow the first subject and/or the primary subject in the field of view of the camera), the computer system shifts, based on the movement of the first subject, the field of view of the camera (e.g., in accordance with a determination that the movement of the first subject is in a first direction, the computer system shifts the field of view of the camera to a third field of view (e.g., in the first direction and/or a direction corresponding to the first direction). In some examples, after (and/or in response to) detecting the movement of the first subject and in accordance with a determination that the movement of the first subject is in a second direction different from the first direction, the computer system shifts the field of view of the camera to a fourth field of view (e.g., in the second direction and/or a direction corresponding to the second direction) different from the third field of view). In some examples, before detecting movement of the first subject (and/or while the computer system is in the second mode), the computer system receives a request to change the computer system to the first mode. In some examples, in response to receiving the request to change the computer system to the first mode, the computer system initiates detection of movement of the first subject and/or the primary subject in the field of view of the camera. In some examples, after (and/or in response to) detecting the movement of the first subject and in accordance with a determination that the computer system is in a second mode (e.g., a mode in which the computer system causes the camera to follow the other computer system and/or a pose of the other computer system (e.g., the other computer system controls the camera by sending a pose to the computer system)) different from the first mode, the computer system forgoes shifting, based on the movement of the first subject, the field of view of the camera (and/or shifts, based on movement of the other computer system and/or a pose received from the other computer system). In some examples, before or after detecting movement of the first subject (and/or while the computer system is in the first mode), the computer system receives a request to change the computer system to the second mode. In some examples, in response to receiving the request to change the computer system to the second mode, the computer system forgoes and/or stops detection of movement of the first subject and/or the primary subject in the field of view of the camera. In some examples, in response to receiving the request to change the computer system to the second mode, the computer system waits and/or maintains a current field of view until receiving a pose from the other computer system.

In some examples, the computer system is a first computer system. In some examples, shifting the field of view of the camera (e.g., in response to detecting that the focus direction of the first subject is in the second direction and/or after (and/or in response to) detecting the movement of the first subject) includes sending, to a second computer system (e.g., a mount and/or an electronic device coupled to and/or attached to the first computer system) different from the first computer system, a request to move a physical component of the second computer system (e.g., which, when moved, causes the camera to be physically moved, causing the field of view of the camera to be shifted).

In some examples, the computer system includes (and/or is in communication with) a movement component (e.g., an actuator (e.g., a pneumatic actuator, hydraulic actuator and/or an electric actuator), a movable base, a rotatable component, a motor, a lift, a level, and/or a rotatable base). In some examples, shifting the field of view of the camera (e.g., in response to detecting that the focus direction of the first subject is in the second direction and/or after (and/or in response to) detecting the movement of the first subject) includes controlling (and/or moving and/or causing movement of) the movement component (e.g., to move from a first physical position to a second physical position different from the first physical position).

In some examples, the first subject is identified as the primary subject based on which subject is detected to be speaking (and/or most recently has spoken) (e.g., via a microphone of and/or in communication with the computer system) (e.g., the first subject is identified as the primary subject when the first subject is speaking and/or most recently spoke and another subject different from the first subject is not speaking and/or did not most recently speak).

In some examples, the first subject is identified as the primary subject based on which subject is gazing (and/or looking) at the camera (and/or the computer system)(and/or gaze exceeds a threshold, such as a time threshold gazing at the camera) (and/or most recently has gazed at the camera) (e.g., via a camera of and/or in communication with the computer system) (e.g., the first subject is identified as the primary subject when the first subject is looking and/or most recently looked at the camera and another subject different from the first subject is not looking and/or did not most recently look at the camera).

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve capture of images and/or videos. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, a camera frame can be changed based on movement and/or other non-identifying and/or non-personal characteristics of a subject or a bare minimum amount of identifying and/or personal information.

What is claimed is:

1. A method, comprising:
receiving, via a camera that is in communication with a computer system, data representing a view of the camera;
identifying, based on the data, a first subject as a primary subject in the view of the camera;
after identifying the first subject as the primary subject in the view of the camera, detecting that a focus direction of the first subject is in a second direction; and
in response to detecting that the focus direction of the first subject is in the second direction, shifting the view of the camera.

2. The method of claim 1, wherein shifting the view of the computer system includes moving a direction that the camera is facing.

3. The method of claim 2, wherein moving the direction that the camera is facing includes sending, to a second computer system that is different from the computer system, a request to move a physical component of the second computer system.

4. The method of claim 1, wherein the first subject is identified as the primary subject based on a proximity of the first subject to a center of the view of the camera.

5. The method of claim 1, wherein the first subject is identified as the primary subject based on a proximity of the first subject to the camera.

6. The method of claim 1, wherein the first subject is identified as the primary subject based on an analysis of one or more previously captured images.

7. The method of claim 1, wherein the first subject is identified as the primary subject based on a length of time that the first subject has been identified in the view of the camera.

8. The method of claim 1, further comprising:
while the first subject is identified as the primary subject, identifying that the first subject has not been in the view of the camera for a threshold amount of time;
in response to identifying that the first subject has not been in the view of the camera for the threshold amount of time, identifying a second subject as the primary subject, wherein the second subject is different from the first subject;
detecting, based on second data received via the camera, a focus direction of the second subject; and
in response to detecting that the focus direction of the second subject is in a fourth direction, shifting the view of the camera.

9. The method of claim 1, wherein shifting the view of the camera includes moving the view of the camera in the second direction.

10. The method of claim 1, wherein shifting the view of the camera includes moving the view of the camera until the first subject is located at a predefined location within the view of the camera.

11. The method of claim 1, wherein shifting the view of the camera includes moving the view of the camera until a subject in the second direction is in the view of the camera.

12. The method of claim 1, wherein shifting the view of the camera includes moving the view of the camera a predetermined amount in the focus direction.

13. The method of claim 1, wherein the computer system includes the camera.

14. The method of claim 1, wherein a third electronic device, different from the computer system, includes the camera.

15. The method of claim 1, wherein the view of the camera is shifted in response to detecting that the focus direction of the first subject changed from a first direction to the second direction.

16. The method of claim 1, further comprising:
receiving, from another computer system different from the computer system, a respective pose corresponding to the other computer system; and
in response to receiving the respective pose corresponding to the other computer system:
in accordance with a determination that the respective pose is a first pose, shifting the field of view of the camera to a first field of view; and
in accordance with a determination that the respective pose is a second pose different from the first pose, shifting the field of view of the camera to a second field of view different from the first field of view.

17. The method of claim 16, wherein the respective pose of the other computer system is received as part of a telecommunication call between the computer system and the other computer system.

18. The method of claim 16, further comprising:
after shifting the field of view to the first field of view, detecting, via the camera, movement of the first subject; and
after detecting the movement of the first subject:
in accordance with a determination that the computer system is in a first mode, shifting, based on the movement of the first subject, the field of view of the camera; and
in accordance with a determination that the computer system is in a second mode different from the first mode, forgoing shifting, based on the movement of the first subject, the field of view of the camera.

19. The method of claim 1, wherein the computer system is a first computer system, and wherein shifting the field of view of the camera includes sending, to a second computer system different from the first computer system, a request to move a physical component of the second computer system.

20. The method of claim 1, wherein the computer system includes a movement component, and wherein shifting the field of view of the camera includes controlling the movement component.

21. The method of claim 1, wherein the first subject is identified as the primary subject based on which subject is detected to be speaking.

22. The method of claim 1, wherein the first subject is identified as the primary subject based on which subject is gazing at the camera.

23. A non-transitory computer-readable storage medium storing one or more programs configured to be executed by one or more processors, the one or more programs including instructions for:
receiving, via a camera that is in communication with a computer system, data representing a view of the camera;
identifying, based on the data, a first subject as a primary subject in the view of the camera;
after identifying the first subject as the primary subject in the view of the camera, detecting that a focus direction of the first subject is in a second direction; and
in response to detecting that the focus direction of the first subject is in the second direction, shifting the view of the camera.

24. An electronic device, comprising:
one or more processors; and
memory storing one or more programs configured to be executed by the one or more processors, the one or more programs including instructions for:
receiving, via a camera that is in communication with a computer system, data representing a view of the camera;
identifying, based on the data, a first subject as a primary subject in the view of the camera;
after identifying the first subject as the primary subject in the view of the camera, detecting that a focus direction of the first subject is in a second direction; and
in response to detecting that the focus direction of the first subject is in the second direction, shifting the view of the camera.
